(19) United States
(12) Patent Application Publication
(10) Pub. No.: US 2026/0229729 A1
(43) Pub. Date: Aug. 6, 2026

(54) ELECTRODE ASSEMBLY AND SECONDARY BATTERY COMPRISING THE ELECTRODE ASSEMBLY

(71) Applicant: SAMSUNG SDI CO., LTD., Yongin-si (KR)

(72) Inventors: So Yeon KIM, Yongin-si (KR); Young Jae CHO, Yongin-si (KR); Jung Hyun KIM, Yongin-si (KR); Jun Ho YANG, Yongin-si (KR); Hyun Suk PARK, Yongin-si (KR); Dae June JEONG, Yongin-si (KR); Im Hyuck BAE, Yongin-si (KR)

(21) Appl. No.: 19/298,445

(22) Filed: Aug. 13, 2025

(30) Foreign Application Priority Data
Feb. 4, 2025 (KR) 10-2025-0013525

(51) Int. Cl. H01M 50/538; B60L 50/60; H01M 10/0525; H01M 10/0587; H01M 50/107; H01M 50/533; H01M 50/536

(52) U.S. Cl. CPC H01M 50/538; H01M 10/0525; H01M 10/0587; H01M 50/107; H01M 50/533; H01M 50/536; B60L 50/66; H01M 2220/20

(57) ABSTRACT

Disclosed is a secondary battery including an electrode assembly having a first electrode plate, a second electrode plate, a separator interposed between the first electrode plate and the second electrode plate, a first electrode current collector plate electrically connected to the first electrode plate, a second electrode current collector plate electrically connected to the second electrode plate, and a can accommodating the electrode assembly.

### CROSS-REFERENCE TO RELATED APPLICATION

This application claims priority to and the benefit of Korean Patent Application No. 10-2025-0013525 filed on Feb. 4, 2025, in the Korean Intellectual Property Office, the entire disclosure of which is incorporated herein by reference.

### BACKGROUND

### 1. Field

The present disclosure relates to an electrode assembly and a secondary battery comprising the electrode assembly and, more specifically, to a cylindrical secondary battery.

### 2. Description of the Related Art

Unlike a primary battery that cannot be charged, a secondary battery is a rechargeable and dischargeable battery. A low-capacity secondary battery may be used for various portable small-sized electronic devices, such as a smartphone, a feature phone, a notebook computer, a digital camera, or a camcorder, and a high-capacity secondary battery is widely used as a power source for motor drives, such as those in hybrid vehicles or electric vehicles, and the like, and power storage cell batteries. These secondary batteries may include an electrode assembly consisting of a positive electrode and a negative electrode, a case that accommodates the electrode assembly, and electrode terminals connected to the electrode assembly.

The above information disclosed in this Background section is for enhancement of understanding of the background of the present disclosure, and therefore, it may contain information that does not constitute related (or prior) art.

### SUMMARY

The present disclosure provides a secondary battery having improved welding strength between a substrate tab and a current collector plate of an electrode assembly.

An electrode assembly according to one embodiment of the present disclosure for solving a technical problem, may include a first electrode plate, a second electrode plate, a separator interposed between the first electrode plate and the second electrode plate, wherein: the first electrode plate includes a plurality of first electrode substrate tabs, each of the plurality of first electrode substrate tabs including a first electrode bent portion, resulting in a plurality of first electrode bent portions, wherein heights of the plurality of first electrode bent portions of the first electrode substrate tabs increase from a first side of the electrode assembly toward a winding core portion of the electrode assembly, and the second electrode plate includes a plurality of second electrode substrate tabs, each of the plurality of second electrode substrate tabs including a second electrode bent portion, resulting in a plurality of second electrode bent portions, wherein heights of the plurality of second electrode bent portions of the second electrode substrate tabs increase from a second side of the electrode assembly toward the winding core portion of the electrode assembly.

In some configurations, among the plurality of first electrode substrate tabs, an overall length of a first electrode substrate tab closest to the winding core portion of the electrode assembly is different from an overall length of a first electrode substrate tab closest to the winding end portion of the electrode assembly, and among the plurality of second electrode substrate tabs, an overall length of a second electrode substrate tab that is closest to the winding core portion of the electrode assembly is different from an overall length of a second electrode substrate tab that is closest to the winding end portion of the electrode assembly.

In some configurations, lengths of each of the plurality of first electrode substrate tabs may increase from the first side of the electrode assembly to the winding core portion, and lengths of each of the plurality of second electrode substrate tabs may increase from the second side of the electrode assembly to the winding core portion.

An electrode assembly according to still another embodiment of the present disclosure may include a first electrode plate, a second electrode plate, a separator interposed between the first electrode plate and the second electrode plate, wherein: the first electrode plate includes a plurality of first electrode substrate tabs, each of the plurality of first electrode substrate tabs including a bent portion, resulting in a plurality of first electrode bent portions, and a lower end portion extending from the bent portion towards a first surface of the electrode assembly, resulting in a plurality of first electrode lower end portions, the second electrode plate includes a plurality of second electrode substrate tabs, each of the plurality of second electrode substrate tabs including a bent portion, resulting in a plurality of second electrode bent portions, and a lower end portion extending from the bent portion towards a second surface of the electrode assembly, resulting in a plurality of first electrode lower end portions, the plurality of first electrode lower end portions of the first electrode substrate tabs are formed in a first diagonal shape having a first predetermined angle with respect to the first surface of the electrode assembly, and the plurality of second electrode bent portions of the second electrode substrate tabs are formed in a second diagonal shape having a second predetermined angle with respect to the second surface of the electrode assembly.

In some configurations, the first electrode substrate tabs may further include a plurality of first electrode upper end portions connected to upper portions of the plurality of first electrode bent portions and formed parallel to the first surface of the electrode assembly, and the second electrode substrate tabs may further include a plurality of second electrode upper end portions connected to upper portions of the plurality of second electrode bent portions and formed parallel to the second surface of the electrode assembly

In some configurations, the plurality of first electrode lower end portions and the plurality of first electrode upper end portions extend in different directions with respect to the plurality of first electrode bent portions, and the plurality of second electrode lower end portions and the plurality of second electrode upper end portions extend in different directions with respect to the plurality of second electrode bent portions.

In some configurations, the electrode assembly can further include: a plurality of first leading-edge tabs adjacent to the plurality of first electrode substrate tabs and positioned closer to a winding core portion of the electrode assembly than the plurality of first electrode substrate tabs, and a plurality of second leading-edge tabs adjacent to the plurality of second electrode substrate tabs and positioned closer to the winding core portion of the assembly than the plurality of second electrode tabs.

In some configurations, the plurality of first leading-edge tabs and the plurality of second leading-edge tabs are formed at a same height as the first surface or the second surface of the electrode assembly.

In some configurations, the plurality of first leading-edge tabs and the plurality of second leading-edge tabs are shorter than a first height of the bent portion of a most adjacent first electrode substrate tab within the plurality of first electrode substrate tabs, and the plurality of first leading-edge tabs and the plurality of second leading-edge tabs are shorter than a second height of the bent portion of a most adjacent second electrode substrate tab within the plurality of second electrode substrate tabs.

In some configurations, a first overall length of each first electrode tab within the plurality of first electrode tabs and a second overall length of the each second electrode tab within the plurality of second electrode tabs become shorter when moving from a winding core portion to a winding end portion of the electrode assembly.

A secondary battery according to another embodiment of the present disclosure may include: an electrode assembly having a first electrode plate, a second electrode plate, and a separator interposed between the first electrode plate and the second electrode plate, a first electrode collector plate electrically connected to the first electrode plate and a second electrode collector plate electrically connected to the second electrode plate, and a can accommodating the electrode assembly, wherein: the first electrode plate includes a plurality of first electrode substrate tabs, each of the plurality of first electrode substrate tabs including a bent portion, resulting in a plurality of first electrode bent portions, first heights of the plurality of first electrode bent increasing from a first surface of the electrode assembly toward a winding core portion of the electrode assembly, and the second electrode plate includes a plurality of second electrode substrate tabs, each of the plurality of second electrode substrate tabs including a bent portion, resulting in a plurality of second electrode bent portions, second heights of the plurality of second electrode bent portions increasing from a second surface of the electrode assembly toward the winding core portion of the electrode assembly.

In some configurations, among the plurality of first electrode substrate tabs, an overall length of a first electrode substrate tab closest to the winding core portion of the electrode assembly is different from an overall length of the first electrode substrate tab closest to a winding end portion of the electrode assembly, and among the plurality of second electrode substrate tabs, an overall length of the second electrode substrate tab that is closest to the winding core portion of the electrode assembly is different from an overall length of a second electrode substrate tab that is closest to the winding end portion of the electrode assembly.

In some configurations, first upper end portions of the first electrode substrate tabs may be connected to the first electrode collector plate, and second upper end portions of the second electrode substrate tabs may be connected to the second electrode collector plate.

In some configurations, the can may be formed in a cylindrical shape, and the first electrode collector plate and the second electrode collector plate may be formed in a disc shape, a diameter of the first electrode collector plate may be smaller than the diameter of the can, and the second electrode collector plate may include a disc-shaped plate surface portion and a contact portion extending from the disc-shaped plate surface portion.

In some configurations, the plurality of first electrode substrate tabs sequentially shorten in length from the winding core portion to the winding end portion of the electrode assembly, and the plurality of second electrode substrate tabs sequentially shorten in length from the winding core portion to the winding end portion of the electrode assembly.

In some configurations, the plurality of first electrode substrate tabs may further include a plurality of first electrode substrate tab groups, each group within the plurality of first electrode substrate tab groups comprising electrode substrate tabs having a first same length, wherein an electrode substrate tab length within each group within the plurality of first electrode substrate tab groups may be longest at the winding core portion of the electrode assembly and shortest at a winding end portion, and the plurality of second electrode substrate tabs may further include a plurality of second electrode substrate tab groups, each group within the plurality of second electrode substrate tab groups comprising electrode substrate tabs having a second same length, and an electrode substrate tab length within each group within the plurality of second electrode substrate tab groups may be longest at the winding core portion of the electrode assembly and shortest at the winding end portion.

In some configurations, the first electrode tab lower end portions of the first electrode substrate tabs and the second electrode tab lower end portions of the second electrode substrate tabs may be shaped to incline toward the winding core portion from a winding end portion of the electrode assembly.

In some configurations, when bonding a substrate tab and a collector plate together, weld strength can be enhanced by enlarging the area where the-substrate tab overlaps the collector plate.

These and other aspects and features of the present disclosure will be described in or will be apparent from the following description of embodiments of the present disclosure.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 is a schematic perspective view showing an example of a secondary battery according to an embodiment of the present disclosure.

FIG. 2 is a cross-sectional view showing an example of the secondary battery of FIG. 1.

FIGS. 3 and 4 are a perspective view and a cross-sectional view showing an example of a secondary battery according to another embodiment of the present disclosure, respectively.

FIG. 5 schematically shows showing an example of a configuration of an electrode assembly according to a prior art.

FIG. 6 schematically shows showing an example of coupling between electrode substrate tabs and an electrode current collector of the electrode assembly shown in FIG. 5.

FIG. 7 shows showing an example of a plurality of first electrode substrate tabs and a plurality of second electrode substrate tabs of an electrode assembly according to an embodiment of the present disclosure.

FIG. 8 shows showing an example of a diagram in which primary oblique compaction is applied to a plurality of first electrode substrate tabs by using a jig from the outermost portion inwardly, that is, in the direction of a winding core.

FIG. 9 shows showing an example of a diagram in which second compaction is applied to the first electrode substrate tabs on which oblique compaction has been performed in FIG. 8 vertically from top to bottom.

FIG. 10 schematically shows showing an example of an electrode current collector is coupled to an electrode assembly after substrate tab compaction performed in two stages through FIGS. 7 to 9.

FIG. 11 is a cross-sectional view showing an example of an electrode assembly including electrode substrate tabs according to another embodiment of the present disclosure.

FIG. 12 is a cross-sectional view showing an example of an electrode assembly in which primary compaction has been applied to the electrode substrate tabs of the electrode assembly according to FIG. 11.

FIG. 13 is a cross-sectional view showing an example of an electrode assembly including electrode substrate tabs according to another embodiment of the present disclosure.

FIG. 14 is a cross-sectional view showing an example of an electrode assembly in which primary compaction has been applied to the electrode substrate tabs of the electrode assembly according to FIG. 13.

FIGS. 15 and 16 are perspective views showing an example of a battery pack including an exemplary secondary battery according to the present disclosure.

FIGS. 17 and 18 are perspective and side views showing an example of a vehicle including an exemplary battery pack according to the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a). References to two compared elements, features, etc. as being “the same” may mean that they are “substantially the same”.

Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be arranged in contact with the upper (or lower) surface of the element, and another element may also be interposed between the element and the arbitrary element located on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used in this specification are for describing embodiments of the present disclosure and are not intended to limit the present disclosure.

Hereinafter, an electrode assembly and a secondary battery including the electrode assembly according to embodiments of the present disclosure will be described in detail with reference to the attached drawings.

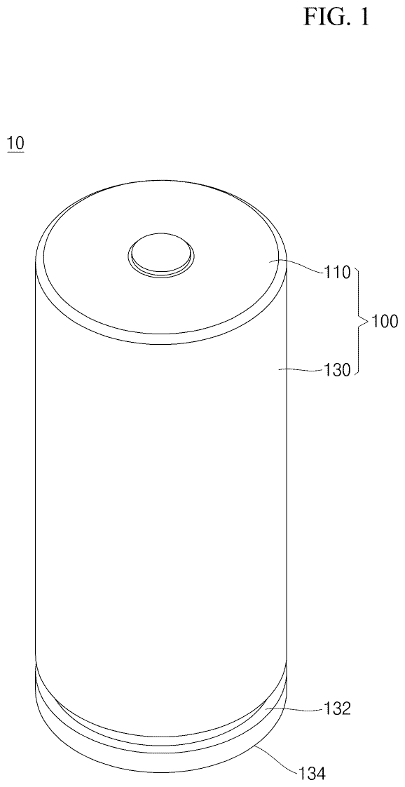

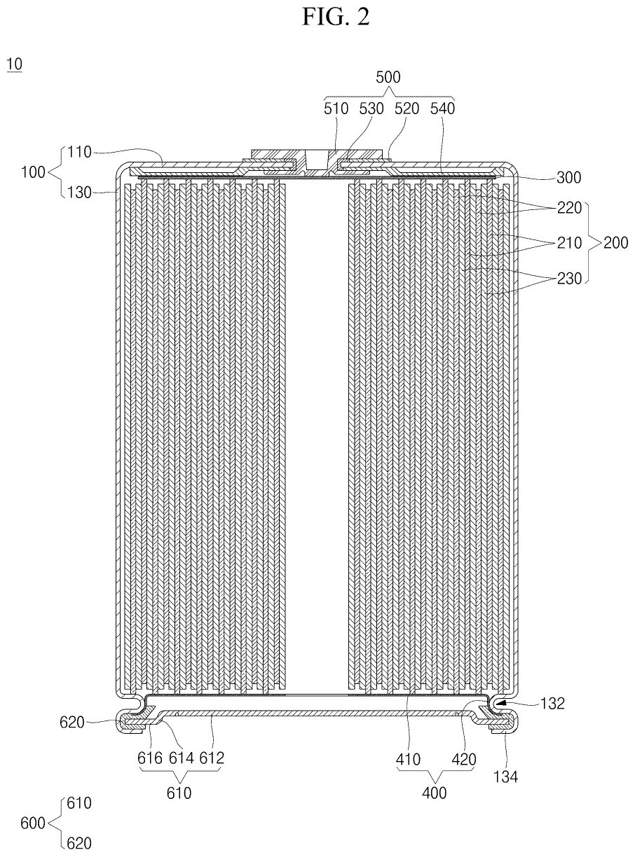

FIG. 1 is a schematic perspective view of a secondary battery 10 according to an embodiment of the present disclosure, and FIG. 2 is a cross-sectional view of the secondary battery 10 of FIG. 1. Referring to FIGS. 1 and 2, the secondary battery 10 according to one embodiment of the present disclosure may include a can 100, an electrode assembly 200, a first electrode collector plate 300 and a second electrode collector plate 400 accommodated inside the can, a terminal portion 500 provided on one side of the can, and a cap assembly 600 provided on the other side of the can.

As shown in FIG. 1, the can 100 may include a circular top surface portion 110 and a cylindrical side portion 130 extending downward from the top surface portion 110. A terminal hole may be formed passing through the center of the top surface portion 110. A portion of the terminal portion may be exposed to the outside of the secondary battery 10 through the terminal hole.

The upper end of the side portion 130 may be connected to the top surface portion 110 to be formed integrally therewith, and the lower end of the side portion 130 may be open, and a cap assembly 600 may be provided at the open end. In the side portion 130, a beading part 132 may be formed adjacent to the lower end. The beading part 132 may be formed concavely inwardly from the side portion 130. The end portion spaced from the beading part 132 can be bent toward the inside of the can 100 to form a crimping part 134. By the beading part 132, the separation of the electrode assembly 200 can be prevented. The assembly 600 may be placed between the beading part 132 and the crimping part 134. The crimping part 134 fixes the cap assembly 600 to seal the can 100.

The can 100 having the above-mentioned configuration may be formed of steel, a steel alloy, aluminum, an aluminum alloy, or an equivalent thereof, but the material is not limited thereto. Inside the can 100, the electrode assembly 200, the first electrode collector plate 300, and the second electrode collector plate 400 are accommodated together with an electrolyte.

As shown in FIG. 2, the electrode assembly 200 may be cylindrically wound such that a first electrode plate 210 and a second electrode plate 220, and a separator 230 interposed therebetween. In the present disclosure, the first electrode plate 210 is described as a positive electrode plate, and the second electrode plate 220 is described as a negative electrode plate, but the opposite configuration may be possible.

The first electrode plate 210 may have a positive electrode active material layer formed on at least one surface of an aluminum (AI) foil by coating, etc. For example, the positive electrode active material layer may be made of a transition metal oxide (LiCoO2, LiNiO2, LiMn2O4, etc.). The first electrode plate 210 may have a first electrode uncoated portion on which the positive electrode active material layer is not formed. A plurality of first electrode substrate tabs 212 may be formed by cutting the first electrode uncoated portion into a predetermined shape by notching, etc. The first electrode substrate tabs 212 may be arranged toward the top surface portion 110 of the can 100. In addition, the first electrode substrate tabs 212 may be electrically connected to the first electrode collector plate 300. For example, the first electrode substrate tabs 212 may be bent in one direction and then coupled to the first electrode collector plate 300 by welding.

The second electrode plate 220 may have a negative electrode active material layer formed on at least one surface of a copper (Cu) or nickel (Ni) foil by coating, etc. For example, the negative electrode active material layer may be made of graphite, carbon, etc. The second electrode plate 220 may have a second electrode uncoated portion on which the negative electrode active material layer is not formed. A plurality of second electrode substrate tabs 222 may be formed by cutting the second electrode uncoated portion into a predetermined shape by notching, etc. The second electrode substrate tabs 222 may be arranged toward the bottom of the can 100. In addition, the second electrode substrate tabs 222 may protrude downward from the separator 230 and may be electrically connected to the second electrode collector plate 400. Portions of the second electrode substrate tabs 222 may be electrically connected to the beading part 132 of the can 100. For example, the second electrode substrate tabs 222 may be bent in one direction and then coupled to the second electrode collector plate 400 by welding.

The separator 230 may be made of polyethylene (PE) or polypropylene (PP), but is not limited thereto in the present disclosure. The separator 230 may prevent an electrical short between the first electrode plate 210 and the second electrode plate 220, and may only allow the movement of lithium ions. The separator 230 may have a length that allows the first electrode collector plate 400 to be brought into contact with the first electrode collector plate 400 on the basis of the longitudinal direction of the electrode assembly 200.

As the positive electrode active material, a compound capable of reversibly intercalating/deintercalating lithium (e.g., a lithiated intercalation compound) may be used. For example, at least one of a composite oxide of lithium and/or a metal selected from cobalt, manganese, nickel, and/or combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c}(0.90≤a≤1.8, 0≤b≤0.5, 0≤c≤0.05); LiₐMn_{2-b}X_{b}O_{4-c}Dc(0.90≤a≤1.8, 0≤b≤0.5, 0≤c≤0.05); LiₐNi_{1-b-c}Co_{b}X_{c}O_{2-α}D_{α}(0.90≤a≤1.8, 0≤b≤0.5, 0≤c≤0.5, 0<α<2); LiₐNi_{1-b-c}Mn_{b}X_{c}O_{2-α}D_{α}(0.90≤a≤1.8, 0≤b≤0.5, 0≤c≤0.5, 0<α<2); LiₐNi_{b}Co_{c}L¹_{d}GₑO₂(0.90≤a≤1.8, 0≤b≤0.9, 0≤c≤0.5, 0≤d≤0.5, 0≤e≤0.1); LiₐNiG_{b}O₂(0.90≤a≤1.8, 0.001≤b≤0.1); LiₐCoG_{b}O₂(0.90≤a≤1.8, 0.001≤b≤0.1); LiₐMn_{1-b}G_{b}O₂(0.90≤a≤1.8, 0.001≤b≤0.1); LiₐMn₂G_{b}O₄(0.90≤a≤1.8, 0.001≤b≤0.1); LiₐMn_{1-g}G_{g}PO₄(0.90≤a≤1.8, 0≤g≤0.5); Li_{(3-f)}Fe₂(PO₄)₃(0≤f≤2); LiₐFePO₄(0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L1 is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x≤2), a Si-based alloy, or a combination thereof.

The silicon-carbon composite may be a composite of silicon and amorphous carbon. According to some embodiments, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer located on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based heavy antibody or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

The electrode assembly 200 having the above-described configuration is electrically connected to the first electrode collector plate 300 and the second electrode collector plate 400, and electrically connected to the terminal portion 500 and the can 100, respectively.

The first electrode collector plate 300 has a disc shape and may be made of the same material as the first electrode plate 210. For example, the first electrode collector plate 300 may be made of aluminum or an aluminum alloy. The diameter of the first electrode collector plate 300 may be smaller than the diameter of the can 100. This is to prevent the first electrode collector plate 300 from being electrically connected to the can 100. The first electrode collector plate 300 may be welded in a state in which the lower surface thereof is in contact with the first electrode substrate tab 212. Accordingly, the first electrode collector plate 300 and the first electrode plate 210 may be electrically connected. In addition, the first electrode collector plate 300 may have an upper surface welded to a rivet terminal 510 of the terminal portion 500. Accordingly, the first electrode collector plate 300 and the rivet terminal 510 may be electrically connected. That is, the first electrode collector plate 300 serves as a passage for current flow between the first electrode plate 210 and the rivet terminal 510.

The second electrode collector plate 400 may include a disc-shaped plate surface portion 410 and a contact portion 420 extending from the plate surface portion 410. Here, the contact portion 420 is an edge region of the second electrode collector plate 400. The upper surface of the plate surface portion 410 may be welded in a state of being in contact with the second electrode substrate tab 222. Accordingly, the second electrode collector plate 400 and the second electrode plate 220 may be electrically connected. To this end, the second electrode collector plate 400 may be made of the same material as the second electrode plate 220. For example, the second electrode collector plate 400 can be made of copper. The contact portion 420 may extend downward from an edge of the plate surface portion 410. The contact portion 420 may be in close contact with the inner surface of the beading part 132. To this end, the contact portion 420 may have a curvature corresponding to the curvature of the beading part 132. For example, the contact portion 420 may be welded to and electrically connected to the beading part 132. However, the second electrode collector plate 400 is not electrically connected to the cap assembly 600.

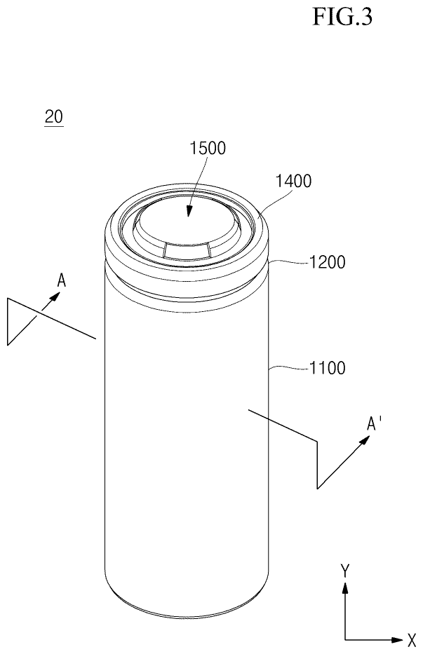

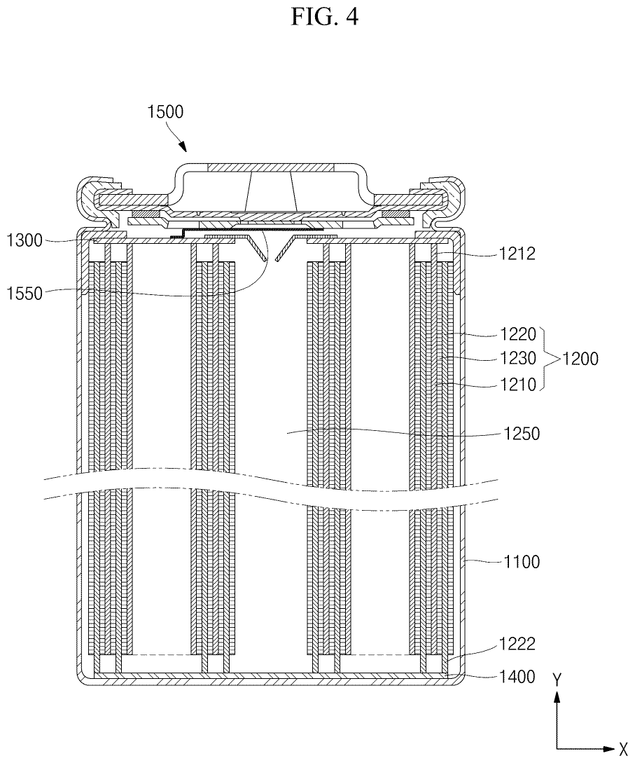

Next, FIGS. 3 and 4 are a perspective view and a cross-sectional view of a secondary battery according to another embodiment of the present disclosure, respectively. The secondary battery shown in FIGS. 3 and 4 differs from the secondary battery having been described with reference to FIGS. 1 and 2 with respect to specific structures, but both secondary batteries have in common the technical idea regarding connections between electrode substrate tabs and electrode current collector plates of a secondary battery according to the present disclosure, which will be described below. For convenience of explanation, descriptions overlapping with those in FIGS. 1 and 2 will be omitted, and for the same and corresponding components, four-digit reference numeral denotation is used by adding “1” to the reference numeral.

Referring to FIGS. 3 and 4, the secondary battery 20 includes a case 1100, an electrode assembly 1200, a cap assembly 1500, a first current collector plate 1300, and a second current collector plate 1400. The electrode assembly 1200 may include a separator 1230, a first electrode plate 1210 and a second electrode plate 1220 positioned with the separator 1230 interposed therebetween, and may be wound in a jelly roll shape.

The first electrode plate 1210 may have a positive electrode active material layer and a first electrode uncoated portion on which the positive electrode active material layer is not formed. A plurality of first electrode substrate tabs 1212 are formed by cutting the first electrode uncoated portion into a predetermined shape by notching, etc.

The second electrode plate 1220 may have a negative electrode active material layer and a second electrode uncoated portion on which the negative electrode active material layer is not formed. A plurality of second electrode substrate tabs 1222 are formed by cutting the second electrode uncoated portion into a predetermined shape by notching, etc.

A hollow portion 1250 may be formed at the center of the electrode assembly 1200, so that when injecting electrolyte into the can, the electrolyte may be easily injected through the hollow portion.

Meanwhile, the first electrode collector plate 1300 and the second electrode collector plate 1400 are respectively arranged on the upper and lower portions of the electrode assembly 1200.

The first electrode collector plate 1300 may be connected to the cap assembly 1500. Specifically, a lead tab 1550 is located between the first electrode collector plate 1300 and the cap assembly 1500. One end of the lead tab 1550 and the first electrode collector plate 1300 can be coupled by welding. Accordingly, the first electrode collector plate 1300 and the cap assembly may be electrically connected by the lead tab.

The second electrode collector plate 1400 is connected to the second electrode plate 1220. Specifically, the second electrode collector plate 1400 is electrically connected to the second electrode substrate tabs 1222. For example, the second electrode collector plate 1400 and the second electrode substrate tabs 1222 are coupled by welding. The second electrode collector plate 1400 is connected to the bottom of the case, and the second electrode collector plate may be coupled to the bottom of the case by welding. Therefore, the second electrode collector plate 1400 may become a passage for current flow between the second electrode plate 1220 and the case. The case can function as a negative electrode.

The regions where the plurality of first and second electrode substrate tabs having been described with reference to FIGS. 1 and 2 are connected to the first and second electrode collector plates, respectively, will now described in more detail. The following descriptions can be equally applied to the regions where the plurality of first and second electrode substrate tabs having been described with reference to FIGS. 3 and 4 are connected to the first and second electrode collector plates, respectively, and therefore redundant descriptions are omitted.

As described above, the first electrode plate is connected to first electrode substrate tabs formed by cutting the first electrode uncoated portion on which the positive electrode active material layer is not formed, and the second electrode plate is connected to second electrode substrate tabs formed by cutting the second electrode uncoated portion on which the negative electrode active material layer is not formed.

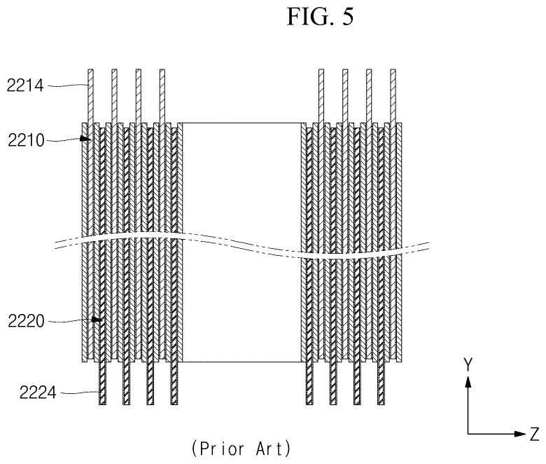

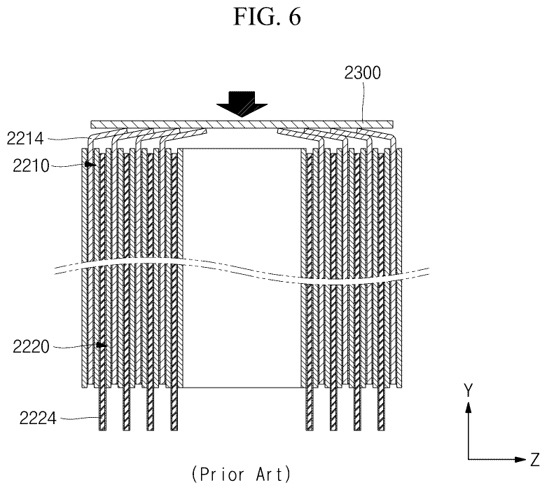

FIG. 5 shows first electrode substrate tabs 2214 of a first electrode plate 2210 and second electrode substrate tabs 2224 of a second electrode plate 2220 in a typical jelly roll-shaped electrode assembly, and FIG. 6 shows coupling of first electrode substrate tabs 2214 shown in FIG. 5 to a first electrode collector plate 2300, for example, welding the first electrode substrate tabs with the first electrode collector plate. Specifically, the first electrode substrate tabs are bent radially, that is, in the winding direction, to be attached to the first electrode collector plate. Although not specifically shown, the second electrode substrate tabs 2224 may also be bent radially, that is, in the winding direction, in the same manner and then welded to the second electrode collector plate.

Referring to FIGS. 5 and 6 showing a conventional welding method, when welding the first electrode substrate tabs that are bent in the winding direction by using the first electrode collector plate, there is a risk of damage to a separator if a sufficient tab overlapping amount in first electrode substrate tabs is not secured. For example, when welding a first electrode collector plate, a certain level of heat energy is applied. In this case, if tab overlapping does not occur sufficiently and a poor contact phenomenon occurs, primary damage is applied to a separator, which is not superior to other components in terms of mechanical properties. To prevent this, if an uncoated portion is formed long enough to provide a sufficient tab overlapping amount, ends of substrate tabs will sag toward the winding core portion, which will create a risk of short circuit when it meets a negative electrode.

Accordingly, in the electrode assembly 200 of a secondary battery according to an embodiment of the present disclosure, while allowing for an overall increase in the tap overlapping amount on the whole through shape changes to first electrode substrate tabs and second electrode substrate tabs, in order to avoid risk of short circuit due to tab end sagging, the first and second electrode collector plates are welded.

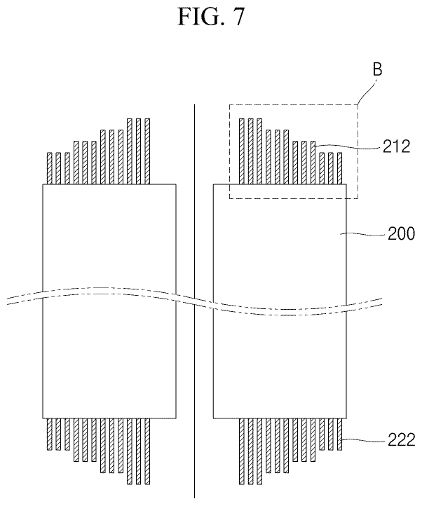

FIG. 7 shows a plurality of first electrode substrate tabs 212 and a plurality of second electrode substrate tabs 222 of an electrode assembly 200 according to an embodiment of the present disclosure.

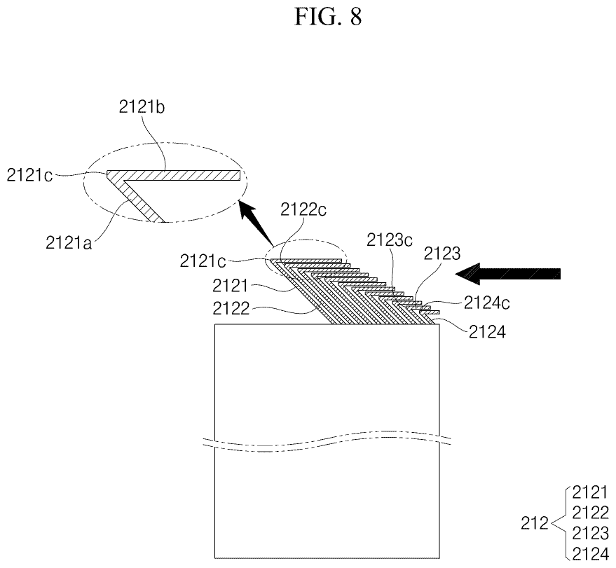

FIG. 8 shows a diagram in which primary oblique compaction is applied by using a jig from the outermost portion inwardly, that is, in the direction of a winding core, to a plurality of first electrode substrate tabs.

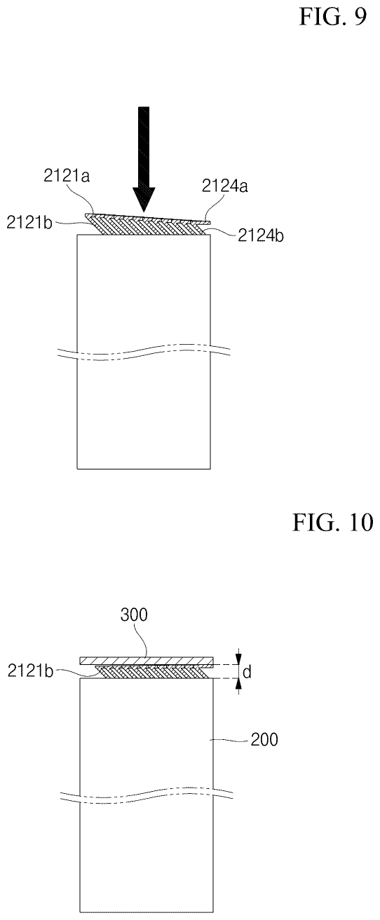

FIG. 9 shows a diagram in which second compaction is applied vertically from top to bottom to the first electrode substrate tabs, which have been obliquely compacted in FIG. 8.

FIGS. 8 and 9 are enlarged views of area B in FIG. 7, but the same content can be of course applied to electrode substrate tabs in other areas within the scope of this disclosure.

For convenience of explanation, in the present disclosure, the description will be made on the basis of the first electrode substrate tabs of a positive electrode, but the contents regarding first electrode substrate tabs can of course be applied to second electrode substrate tabs of a negative electrode within the technical scope of the present disclosure.

Referring to FIGS. 7 to 9, after winding of the electrode assembly, the first electrode substrate tabs are formed such that the length of a first electrode substrate tab 2121; 2122 adjacent to the winding core portion of a first electrode substrate tab 212 is greater than the length of a first electrode substrate tab 2123; 2124 adjacent to the winding end. Although each electrode substrate tab is described as a single unit, it is of course possible to configure a group including multiple substrate tabs. For example, the first electrode substrate tab 2121 may be a group of a plurality of electrode substrate tabs having substantially the same length.

In this way, by forming the first electrode substrate tab 2121; 2122 to have a length greater than the length of the first electrode substrate tab 2123; 2124, the internal resistance of the battery is reduced, while also increasing the tab overlapping length to sufficiently secure the tab overlapping amount, thereby securing welding strength as well. In particular, since the leading edge of the first electrode substrate tab 2121; 2122 is bent in the winding-end direction as shown in FIG. 8, the risk of short circuit occurring due to tab end sagging is eliminated when the tab portion is made long.

In FIGS. 7 to 9, to eliminate the risk of short circuit occurrence, and to facilitate the introduction of a welding device in a process of welding electrode substrate tabs and a current collector plate performed after an electrode substrate tab compaction process, no electrode tab subgroup has been formed inside the first electrode substrate tab 2121; 2122, which amounts to, for example, a case where an electrode substrate tab is not withdrawn for a first electrode plate to be wound, but the number of times it is not withdrawn is not limited.

More specifically, referring to FIGS. 8 and 9, the configuration of the upper and lower end portions of the electrode substrate tabs will be described.

Referring to FIG. 8, the shape after primary oblique compaction is performed on electrode substrate tabs is shown. After primary oblique compaction, at least one of first electrode substrate tabs 2121; 2122; 2123; and 2124 includes at least one bent portion 2121c; 2122c; 2123c; 2124c. The bent portions 2121c; 2122c; 2123c; and 2124c are portions formed by applying a predetermined angle to portions of the electrode substrate tabs by using a jig in the direction (T) from the winding end portion to the winding core portion, that is, from the outer side to the inner side, after forming electrode substrate tabs from an uncoated portion area of an electrode plate through a notching process during the manufacture of a secondary battery.

As is clear from FIG. 8, the heights of the bent portions 2121c; 2122c; 2123c; and 2124c, change based on their positions, such that the heights of the bent portions from one side of the electrode assembly increase toward the winding core portion of the electrode assembly.

The first electrode substrate tab 2121; 2122; 2123; 2124 includes a lower end portion 2121a; 2122a; 2123a; 2124a that is inclined inwardly with respect to the bent portion 2121c; 2122c; 2123c; 2124c and an upper end portion 2121b; 2122b; 2123b; 2124b that is inclined outwardly with respect to the bent portion. The angle between the upper end portion and the lower end portion can be appropriately set by a person skilled in the art according to process conditions or manufacturing environments, and in the present disclosure, the angle is shown as approximately 45 degrees as an example, but is not limited thereto.

Referring to FIG. 9, the shapes of electrode substrate tabs on which secondary compaction has been performed after primary oblique compaction are shown. The upper end portions 2121b, 2122b, 2123b, and 2124b connected to the lower end portions 2121a; 2122a; 2123a; and 2124a of the first electrode substrate tabs 2121; 2122; 2123; and 2124 are arranged parallel on the upper surface of the electrode assembly by overlapping each other. Since the upper end portions of the first electrode substrate tabs are shaped to be inclined in a different direction from the lower end portions, the entire length of the first electrode substrate tabs is sufficient, and thus can enhance welding stability and reduce the internal electrical resistance of a battery, while at the same time, there would be no risk at all that the upper end portion will sag inward, resulting in a short circuit risk or hindering the introduction of a welding device.

FIG. 10 shows a configuration in which welding between positive electrode tabs and a collector plate is performed while applying pressure to a first electrode collector plate 300 in a direction perpendicular to the upper surface of an electrode assembly 200 after substrate tab compaction performed in two stages through FIGS. 7 to 9.

In FIG. 10, a gap (d) is shown as being spaced apart, but after actual welding, the d gap gets close to “0”, which can be confirmed by X-ray or product disassembly while the collector plate and the electrode substrate tabs are in contact with each other.

Referring to FIG. 10, after welding the electrode collector plate, the upper end portions of the electrode substrate tabs are welded substantially parallel to the electrode current collector, starting from the bent portions, and the lower end portions of the electrode substrate tabs are welded obliquely with respect to the upper surface of the electrode assembly, starting from the upper surface of the electrode assembly, so as to extend in the direction toward the winding core portion, that is, inwardly, up to the bent portions.

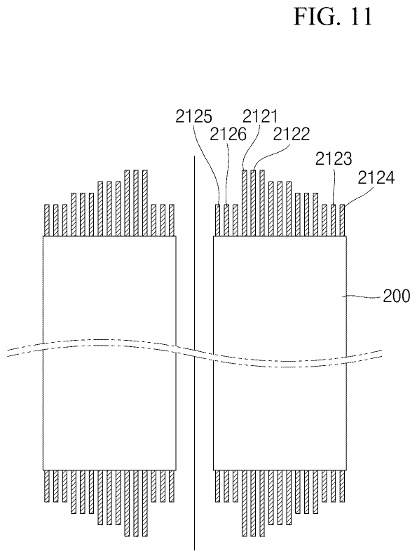

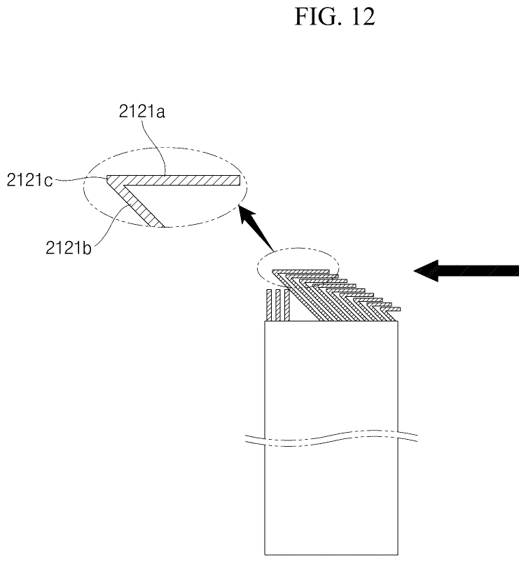

Next, FIGS. 11 and 12 show electrode substrate tabs of an electrode assembly of a secondary battery according to another embodiment of the present disclosure and electrode substrate tabs on which primary oblique compaction has been performed. For convenience of explanation, the contents overlapping with the above description will be omitted, and for a better understanding, the corresponding components to those of FIGS. 7 to 10 are denoted by the same reference numerals.

Referring to FIGS. 11 and 12, a plurality of leading-edge tabs 2125 and 2126 positioned more inward than the first electrode substrate tabs 2121, 2122, 2123, and 2124 may be included. The plurality of leading-edge tabs 2125 and 2126 have substantially the same length. It is preferable that the plurality of leading-edge tabs 2125 and 2156 be positioned lower than at least the height of the first electrode substrate tab 2121, 2122 that is closest thereto. Specifically, It is preferable that the leading-edge tabs are positioned lower than the lower end portions 2121a and 2122a of the first electrode substrate tabs formed after primary oblique compaction. By applying the plurality of leading-edge tabs, substrate tab overlapping useful for strengthening weld-coupling can be added to the winding core portion, and at the same time risks due to substrate tab sagging into the winding core portion can be eliminated.

Thereafter, secondary compaction through a jig in the vertical direction will be performed, and the welding process with the collector plate will then be performed, but detailed descriptions will not be given due to duplication.

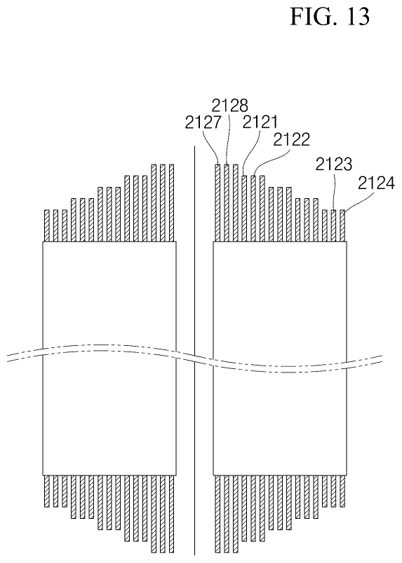

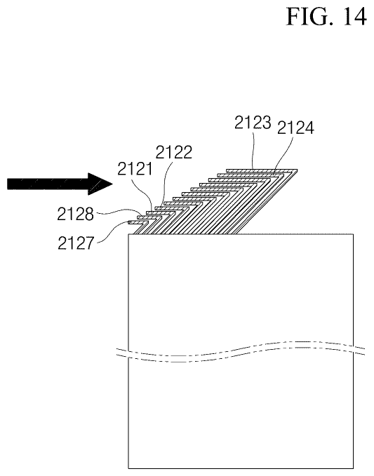

Next, FIGS. 13 and 14 show electrode substrate tabs of an electrode assembly of a secondary battery according to another embodiment of the present disclosure and electrode substrate tabs on which primary oblique compaction has been performed. For convenience of explanation, the contents overlapping with the above description will be omitted, and for a better understanding, the corresponding components to those of FIGS. 7 to 10 are denoted by the same reference numerals.

Referring to FIGS. 13 and 14, in addition to the first electrode substrate tabs 2121, 122, 2123, and 2124, a plurality of additional first electrode substrate tabs 2127 and 2128 may be further formed in an area closer to a winding core portion. The additional first electrode substrate tabs 2127 and 2128 may be formed to be longer than the first electrode substrate tabs 2121 and 2122 that are closer to the winding core portion and are adjacent thereto.

By introducing the additional first electrode substrate tabs, the tab overlapping amount can be increased, while the resistance can also be reduced due to increases in the electrode tab lengths.

Referring to FIG. 14, primary oblique compaction can be applied to the additional first electrode substrate tabs 2127 and 2128 and the first electrode substrate tabs 2121, 2122, 2123, and 2124, from the inner side to the outer side, that is, from the winding core portion to the winding end portion. This completely prevents cases where a short circuit risk may occur due to oblique lower end portions of the additional first electrode substrate tabs sagging toward the winding core portion when primary oblique compaction is applied to the additional first electrode substrate tabs toward the winding core portion.

Meanwhile, although not specifically shown, if there is no concern about the risk of short circuit occurrence, etc. depending on the manufacturing conditions or the specifications of secondary battery required, it may also be possible to apply primary oblique compaction to the electrode substrate tabs shown in FIG. 13 from the outside to the inside.

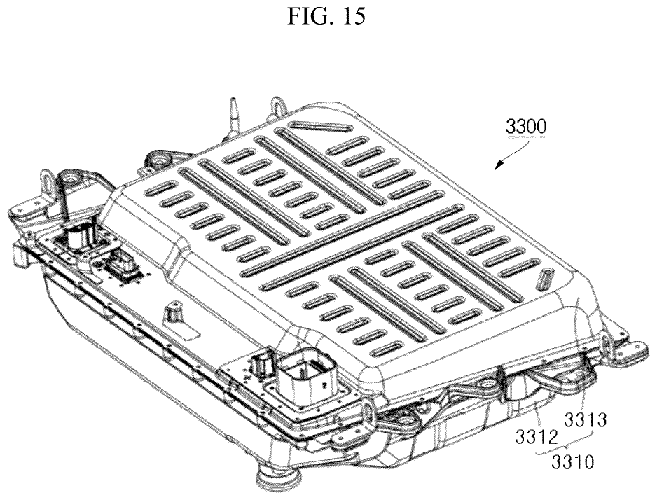

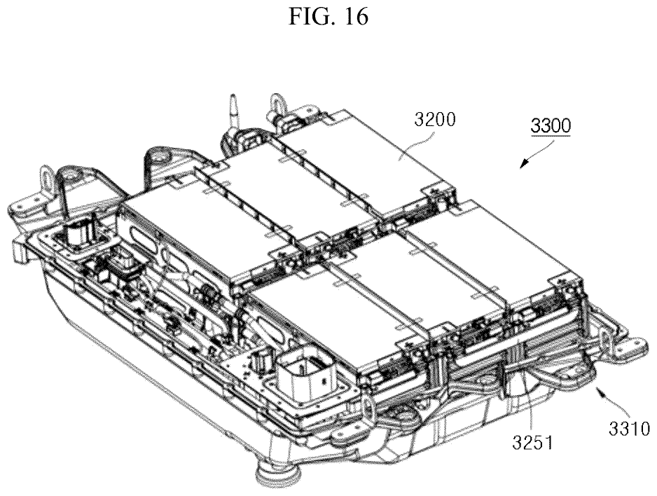

Next, FIGS. 15 and 16 are perspective views showing a battery pack 3300 including an exemplary secondary battery according to the present disclosure.

FIGS. 15 and 16 are perspective views showing a battery pack 3300 including the secondary battery according to some embodiments. Referring to FIGS. 15 and 16, the battery pack 3300 may include a plurality of battery modules 3200 and a housing 3310 for accommodating the plurality of battery modules 3200. For example, the housing 3310 may include first and second housings 3311 and 3312 coupled in opposite directions through the plurality of battery modules 3200. The plurality of battery modules 3200 may be electrically connected to each other by using a bus bar 3251, and the plurality of battery modules 3200 may be electrically connected to each other in a series/parallel or series-parallel mixed method, thereby obtaining desired (e.g., required) electrical output. In the FIGS. 15 and 16, for convenience of illustration, parts such as bus bars, cooling units, and external terminals for electrical connection of battery cells are omitted. In one or more embodiments, battery pack 3300 may be mounted in a vehicle. The vehicle may be, for example, an electric vehicle, a hybrid vehicle, or a plug-in hybrid vehicle. The vehicle may include a four-wheeled vehicle or a two-wheeled vehicle.

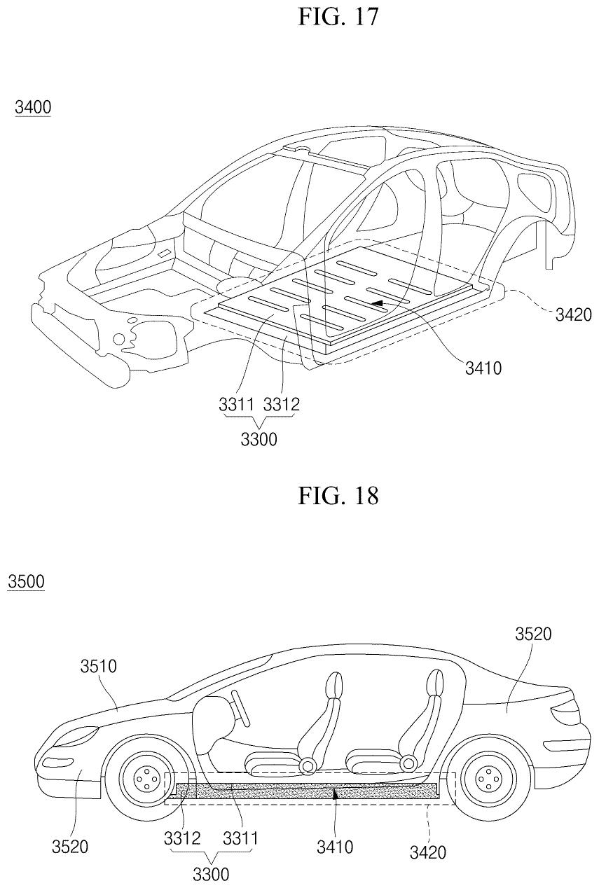

FIGS. 17 and 18 are perspective and side views showing a vehicle 3400, 3500 including an exemplary battery pack 3300 according to the present disclosure.

FIGS. 17 and 18 are perspective and side views showing vehicles including the battery pack 3300 according to some embodiments. In FIG. 14, a battery pack 3300 may include a battery pack cover 3311 (may correspond to the first housing above), which is a part of a vehicle underbody 3410, and a pack frame 3312 (may correspond to the second housing above) located under the vehicle underbody 3410. The pack frame 3312 and the battery pack cover 3311 may be integrally formed with a vehicle floor 3420. The vehicle underbody 3410 separates the inside and outside of a vehicle, and the pack frame 3312 may be located outside the vehicle.

In FIG. 18, a vehicle 3500 may be formed by combining additional parts, such as a hood 3510 in front of the vehicle and fenders 3520 respectively located in the front and rear of the vehicle to a vehicle body parts 3400. The vehicle 3500 may further include a vehicle floor 3420, which is one of the vehicle body parts 3400 including the battery pack 3300 including the pack frame 3312 and the battery pack cover 3311.

However, aspects and features of the present disclosure are not limited to those described above, and other aspects and features not mentioned will be clearly understood by a person skilled in the art from the detailed description, described above.

Although the present disclosure has been described above with limited examples and drawings, the present disclosure is not limited thereto, and it is obvious that various modifications and variations may be made by those skilled in the art in the technical field to which the present disclosure belongs within the technical idea of the present disclosure.

What is claimed is:

1. An electrode assembly comprising:
a first electrode plate;
a second electrode plate; and
a separator interposed between the first electrode plate and the second electrode plate,
wherein the first electrode plate comprises a plurality of first electrode substrate tabs, each of the first electrode substrate tabs including a first electrode bent portion such that the first electrode plate comprises a plurality of first electrode plate bent portions, wherein heights of the plurality of first electrode plate bent portions of the first electrode substrate tabs increase from a first side of the electrode assembly toward a winding core portion of the electrode assembly, and
wherein the second electrode plate comprises a plurality of second electrode substrate tabs, each of the plurality of second electrode substrate tabs including a second electrode plate bent portion such that the second electrode plate comprises a plurality of second electrode plate bent portions, and
wherein heights of the second electrode plate bent portions of the second electrode substrate tabs increase from a second side of the electrode assembly toward the winding core portion of the electrode assembly.

2. An electrode assembly comprising:
a first electrode plate,
a second electrode plate,
a separator interposed between the first electrode plate and the second electrode plate,
wherein the first electrode plate includes a plurality of first electrode substrate tabs, and the second electrode plate includes a plurality of second electrode substrate tabs,
wherein among the plurality of first electrode substrate tabs, an overall length of a first electrode substrate tab closest to the winding core portion of the electrode assembly is different from an overall length of the first electrode substrate tab closest to a winding end portion of the electrode assembly, and
wherein among the plurality of second electrode substrate tabs, an overall length of a second electrode substrate tab that is closest to the winding core portion of the electrode assembly is different from an overall length of the second electrode substrate tab that is closest to the winding end portion of the electrode assembly.

3. The electrode assembly as claimed in claim 1, wherein lengths of each of the plurality of first electrode substrate tabs increase from the first side of the electrode assembly to the winding core portion, and lengths of each of the plurality of second electrode substrate tabs increase from the second side of the electrode assembly to the winding core portion.

4. An electrode assembly comprising:
a first electrode plate;
a second electrode plate; and
a separator interposed between the first electrode plate and the second electrode plate,
wherein the first electrode plate comprises a plurality of first electrode substrate tabs, each of the plurality of first electrode substrate tabs including a bent portion such that the first electrode plate comprises a plurality of first electrode bent portions, and a lower end portion extending from the bent portion towards a first surface of the electrode assembly such that the first electrode plate comprises in a plurality of first electrode lower end portions,
wherein the second electrode plate comprises a plurality of second electrode substrate tabs, each of the plurality of second electrode substrate tabs including a bent portion such that the second electrode plate comprises a plurality of second electrode bent portions, and a lower end portion extending from the bent portion towards a second surface of the electrode assembly such that the second electrode plate comprises in a plurality of second electrode lower end portions,
wherein the first electrode lower end portions of the first electrode substrate tabs are formed in a first diagonal shape having a first predetermined angle with respect to the first surface of the electrode assembly, and
wherein the second electrode bent portions of the second electrode substrate tabs are formed in a second diagonal shape having a second predetermined angle with respect to the second surface of the electrode assembly.

5. The electrode assembly as claimed in claim 4, wherein the first electrode substrate tabs further comprise a plurality of first electrode upper end portions connected to upper portions of the plurality of first electrode bent portions and formed parallel to the first surface of the electrode assembly, and
wherein the second electrode substrate tabs further comprise a plurality of second electrode upper end portions connected to upper portions of the plurality of second electrode bent portions and formed parallel to the second surface of the electrode assembly.

6. The electrode assembly as claimed in claim 5, wherein the plurality of first electrode lower end portions and the plurality of first electrode upper end portions extend in different directions with respect to the plurality of first electrode bent portions, and
wherein the plurality of second electrode lower end portions and the plurality of second electrode upper end portions extend in different directions with respect to the plurality of second electrode bent portions.

7. The electrode assembly as claimed in claim 1, further comprising:
a plurality of first leading-edge tabs adjacent to the plurality of first electrode substrate tabs and positioned closer to a winding core portion of the electrode assembly than the plurality of first electrode substrate tabs; and
a plurality of second leading-edge tabs adjacent to the plurality of second electrode substrate tabs and positioned closer to the winding core portion of the assembly than the plurality of second electrode substrate tabs.

8. The electrode assembly as claimed in claim 7, wherein the plurality of first leading-edge tabs and the plurality of second leading-edge tabs are formed at a same height as the first surface or the second surface of the electrode assembly.

9. The electrode assembly as claimed in claim 7, wherein the plurality of first leading-edge tabs and the plurality of second leading-edge tabs are shorter than a first height of the bent portion of a most adjacent first electrode substrate tab of the plurality of first electrode substrate tabs, and
wherein the plurality of first leading-edge tabs and the plurality of second leading-edge tabs are arranged shorter than a second height of the bent portion of a most adjacent second electrode substrate tab of the plurality of second electrode substrate tabs.

10. The electrode assembly as claimed in claim 4, wherein a first overall length of each first electrode tab of the plurality of first electrode tabs and a second overall length of each second electrode tab of the plurality of second electrode tabs become shorter when moving from a winding core portion to a winding end portion of the electrode assembly.

11. A secondary battery comprising:
an electrode assembly comprising:
a first electrode plate;
a second electrode plate;
a separator interposed between the first electrode plate and the second electrode plate;
a first electrode collector plate electrically connected to the first electrode plate; and
a second electrode collector plate electrically connected to the second electrode plate; and
a can accommodating the electrode assembly, wherein the first electrode plate comprises a plurality of first electrode substrate tabs, each of the plurality of first electrode substrate tabs including a bent portion such that the first electrode plate comprises a plurality of first electrode bent portions, with first heights of the first electrode bent portions increasing from a first surface of the electrode assembly toward a winding core portion of the electrode assembly, and
wherein the second electrode plate comprises a plurality of second electrode substrate tabs, each of the plurality of second electrode substrate tabs including a bent portion such that the second electrode plate comprises a plurality of second electrode bent portions, second heights of the plurality of the second electrode bent portions increasing from a second surface of the electrode assembly toward the winding core portion of the electrode assembly.

12. The secondary battery as claimed in claim 11, wherein among the first electrode substrate tabs, an overall length of a first electrode substrate tab closest to the winding core portion of the electrode assembly is different from an overall length of a first electrode substrate tab closest to a winding end portion of the electrode assembly, and
wherein among the second electrode substrate tabs, an overall length of a second electrode substrate tab that is closest to the winding core portion of the electrode assembly is different from an overall length of a second electrode substrate tab that is closest to the winding end portion of the electrode assembly.

13. The secondary battery as claimed in claim 11, wherein first upper end portions of the first electrode substrate tabs are connected to the first electrode collector plate, and
wherein second upper end portions of the second electrode substrate tabs are connected to the second electrode collector plate.

14. The secondary battery as claimed in claim 11, wherein the can is formed in a cylindrical shape,
wherein the first electrode collector plate and the second electrode collector plate are formed in a disc shape,
wherein a diameter of the first electrode collector plate is smaller than a diameter of the can, and
wherein the second electrode collector plate includes a disc-shaped plate surface portion and a contact portion extending from the disc-shaped plate surface portion.

15. The secondary battery as claimed in claim 11, wherein the first electrode substrate tabs sequentially shorten in length from the winding core portion to a winding end portion of the electrode assembly, and
wherein the second electrode substrate tabs sequentially shorten in length from the winding core portion to the winding end portion of the electrode assembly.

16. The secondary battery as claimed in claim 11, wherein the plurality of first electrode substrate tabs further include a plurality of first electrode substrate tab groups, each group within the plurality of first electrode substrate tab groups comprising electrode substrate tabs having a first same length, wherein an electrode substrate tab length within each group within the plurality of first electrode substrate tab groups is longest at the winding core portion of the electrode assembly and shortest at a winding end portion, and
wherein the plurality of second electrode substrate tabs further include a plurality of second electrode substrate tab groups, each group within the plurality of second electrode substrate tab groups comprising electrode substrate tabs having a second same length, and an electrode substrate tab length within each group within the plurality of second electrode substrate tab groups is longest at the winding core portion of the electrode assembly and shortest at the winding end portion.

17. The secondary battery as claimed in claim 11, wherein first electrode substrate tab lower end portions of the first electrode substrate tabs and second electrode tab lower end portions of the second electrode substrate tabs incline toward the winding core portion from a winding end portion of the electrode assembly.

18. The secondary battery as claimed in claim 12, wherein first electrode substrate tab lower end portions of the first electrode substrate tabs and second electrode tab lower end portions of the second electrode substrate tabs incline toward the winding end portion from the winding core portion of the electrode assembly.
